(19) United States
(12) Patent Application Publication
(10) Pub. No.: US 2009/0271250 A1
(43) Pub. Date: Oct. 29, 2009

(54) METHOD AND SYSTEM FOR PROVIDING AN IN-SITE SALES WIDGET

(75) Inventors: Joseph Sriver, Minneapolis, MN (US); Wade Beavers, Rochester, MN (US); David Borrillo, Rochester, MN (US); Pete Carr, Duluth, MN (US)

Correspondence Address: PERKINS COIE LLP, P.O. BOX 1208, SEATTLE, WA, 98111-1208, US

(73) Assignee: DoApp, Inc., Minneapolis, MN (US)

(21) Appl. No.: 12/429,884

(22) Filed: Apr. 24, 2009

Related U.S. Application Data
(60) Provisional application No. 61/048,140, filed on Apr. 25, 2008.

(51) Int. Cl. G06Q 30/00; G06Q 10/00

(52) U.S. Cl. 705/10; 705/26; 705/27

(57) ABSTRACT

Commerce widgets placed on webpages allow a full purchase transaction (browsing, selecting, and buying the product) to take place on the content owner's site (the host site). Webmasters may set the sale price and collect statistics on buyer behavior and habits. By keeping the entire transaction on the webpage, a visitor/customer is not redirected to another website. In addition, purchases may be made from within a displayed video stream.

### CROSS REFERENCE TO RELATED APPLICATIONS

This application claims priority to U.S. Provisional Application No. 61/1048,140 entitled “METHOD AND SYSTEM FOR PROVIDING AN IN-SITE SALES WIDGET”, filed Apr. 25, 2008, and which is incorporated herein by reference.

This application is related to U.S. patent application Ser. No. 12/121,652 entitled “METHOD AND SYSTEM FOR PROVIDING PURCHASING ON A WIRELESS DEVICE”, filed May 15, 2008, which is incorporated herein by reference.

### BACKGROUND

Websites on the Internet can generate visitor traffic by providing valuable content or otherwise enticing visitors to visit. Such traffic can be monetized in various ways, including selling relevant products or services to the visitors.

Online shopping is the process of purchasing products or services over the Internet. An online shop can be analogous to a physical bricks-and-mortar retailer or in a shopping mall. Presently, many types of stores have retail web sites, including those that do and do not also have physical storefronts and paper catalogs. In another embodiment, the online shop can combine a content website discussed above with functionality selling relevant products and services.

Online shopping provides many benefits over shopping at a physical store. It can be convenient to purchase products or services from one's own home, it is often possible to find a better price due to the large number of online retailers and retailers' overhead, and a wider selection of products and services can be available. In addition, online shopping can provide both information on products in the form of user reviews and the products for sale in one easy-to-use website.

Similar to bricks-and-mortar retailers, online retailers must drive traffic to their website and generate interest in their products. Traditional advertising such as radio, television, print, etc. can be used to increase customer awareness of the website. Alternatively, online advertising such as banner ads, text ads, affiliate networks, etc. can be used.

Electronic workstations or terminals can include personal computers, workstations, desktop computers, mobile device such as cell phones and personal digital assistants (PDAs). Such workstations can be in communications with a network such as the Internet, and configured to access websites with a web browser.

Processing a sales transaction over the Internet is an inherently complex process. Besides generating user traffic and providing product descriptions, a website must be able to process payments and conduct other sales-related functions, such as inventory checking and computing shipping time estimates. Such functionality requires substantial backend infrastructure. Many websites are not set up to handle sales transactions in an efficient and secure manner. Similarly, many website administrators lack the technical skills to set up and manage such backend infrastructure.

Therefore, many websites that sell products or services must refer sales traffic to a third-party sales website. The third-party sales website is set up with the required backend infrastructure to process sales transactions. This requires website administrator to share revenues with the sales website. This also redirects visitors to the sales website and off the original website. Finally, this gives website administrators little control over the sales process, as the process is maintained by the third-party sales website.

Thus, there exists a need to simplify the process of providing online shopping functionality to any desired website.

### BRIEF DESCRIPTION OF DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 depicts an example system for providing a sales widget on a website.

FIG. 2 depicts an example procedure for adding a sales widget to a website.

FIG. 3 depicts an example procedure for completing a sales transaction with a sales widget from a website.

FIG. 4 depicts an example prior art workstation allowing a user to access a website.

FIG. 5 depicts an example widget server for serving widgets over a network.

FIG. 6 illustrates an example prior art mobile device allowing a user to access a website.

### DETAILED DESCRIPTION

A sales widget is added to a website to process sales transactions without redirecting a visitor to an outside website and gives control over the sales process to the website administrator. In one embodiment, the widget displays an appropriate advertisement or offer for sale based on webpage content. In another embodiment, the webpage administrator can select relevant products and services for sale from the sales widget and select whether to fulfill purchases from drop-shippers or internally. Payment processing and other necessary functions are handled by a widget server. This simplifies setting up a website to accept sales transactions, allows a visitor to remain on the website throughout the sales transaction, and provides the website administrator greater control over the sales process.

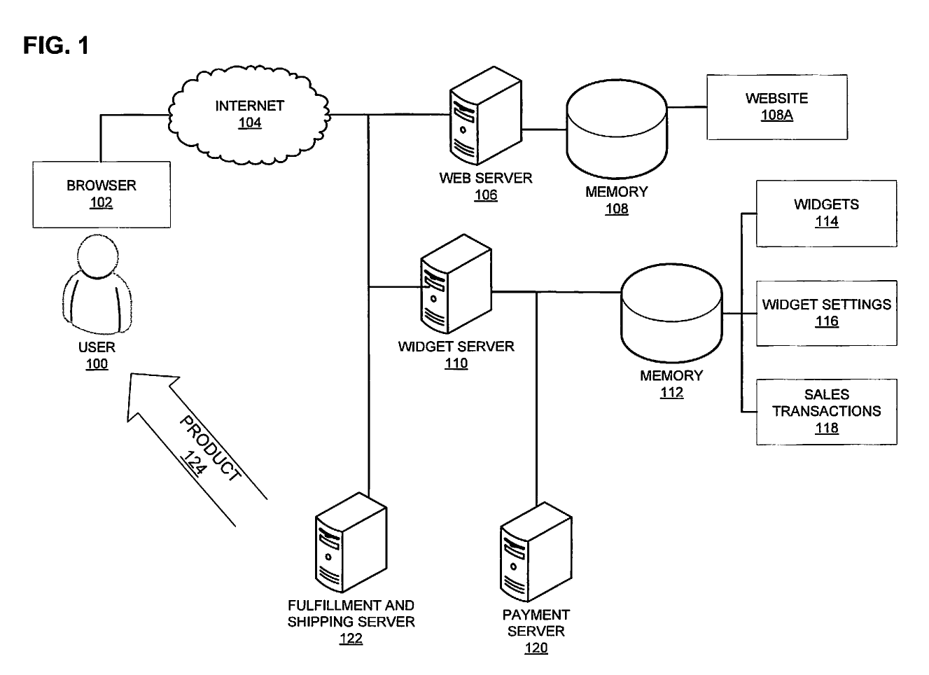

FIG. 1 depicts an example system for providing a sales widget on a website. A user 100 interacts with a browser 102 executing on a computing device such as a workstation. For example, the computing device can be a workstation illustrated below, a personal computer, a thin client, a mobile wireless device, or any other device configured to execute a browser and provide input/output to the user.

The workstation is in communication with a network such as the Internet 104 via a network interface. The browser 102 can interface with a web server 106 over the Internet 104 to access a website. In one embodiment, the user 100 is a visitor to a website and seeks to make a purchase of a product or service offered by the website. One or more communication protocols can be used by the browser 102 and the web server 106 to communicate over the Internet, such as TCP/IP.

The web server 106 includes a memory 108 storing a website 108A. The website 108A includes one or more webpages written in Hypertext Markup Language (HTML) or another language for displaying content to the user 100 on the browser 102. Content can include text, graphics, video, or other multimedia content. The web server 106 can also be in communications with a database to store visitor information and any other modules that help provide the website 108A to the user.

The web server 108 communicates with a widget server 110 over a network, such as the Internet 104 or an internal network. It will be appreciated that while only one network, Internet 104, is illustrated in FIG. 1, any number of networks can connect the various components of the system. The widget server 110 is configured to transmit a sales widget to the browser 102 responsive to a browser request, wherein the browser request is embedded within a webpage, for example, as a Universal Resource Locator (URL) address.

The widget server 110 communicates with a memory 112 that stores sales widgets 114, a set of widget settings 116, and completed sales transactions 118. A widget is a set of computer instructions for execution on the browser to provide sales widget functionality. The sales widget is configured to interface with the user to complete a sales transaction. For example, the sales widget displays available products and services for sale to the user. The sales widget also receives user information (such as a purchase selection, payment information, and shipping information) for forwarding to the widget server.

The widget server 110 can also store video clips or facilitate live streaming of video related to a product for sale to the browser 102. For example, video content can be synchronized with the sales widget on the browser 102 so that when a product is depicted in the video, the sales widget offers the product for sale to the user 100.

The widget server 110 can store and provide multiple widgets of different types and configurations to different websites or webpages within a website. Sales widgets can be configured by their settings, which are stored in memory as widget settings 116. Example widget settings can include the products and services to be offered for sale, a sales widget appearance on the website, fulfillment options, or other settings. Widget settings can be set by a web server administrator, giving the web server administrator great control over the appearance and function of sales widgets and sales transaction processing on the website.

The widget server 110 can save and store completed sales transactions 118 in memory 112. This facilitates recordkeeping by the website administrator and a widget server administrator. Further, the sales transaction data can be used to compile sales statistics for the website 108A, allowing the website administrator to determine optimal product mix and sales widget placement within the website 108A.

After the user submits payment information, for example, a credit card information and authorization, the widget server transmits the payment information to the payment server 120 for processing. For example, the payment server 120 can be a third party payment server such as PayPal.com, or a payment processing module of a credit card company. The payment server 120 charges the credit card and transmits a success or failure message to the widget server 110. If the payment was successfully processed, the widget server 110 proceeds with the sales transaction. If the payment was not successfully processed, the widget server 110 informs the user via the Internet.

It will be appreciated that other forms of payment can be processed, such as electronic checks, debit cards, prepaid cards, or other stores of value.

Once payment has been successfully processed, the widget server 110 transmits shipping information and authorization to a fulfillment and shipping server 122. The fulfillment and shipping server 122 handles inventory control and shipping of products. For example, the fulfillment and shipping server 122 can be an interface module of a drop-shipper. Alternatively, the fulfillment and shipping server can be operated by the website administrator, so that shipping and fulfillment are handled in-house. The fulfillment and shipping server 122 ships the purchased product or provides the purchased service to the user.

It will be appreciated that a website administrator can be responsible for the content of the website 108A, but can outsource handling purchase transactions to the widget server 110. By embedding a URL link to the sales widget and configuring the widget, the website 108A is instantly able to handle sales transactions without further effort by the website administrator.

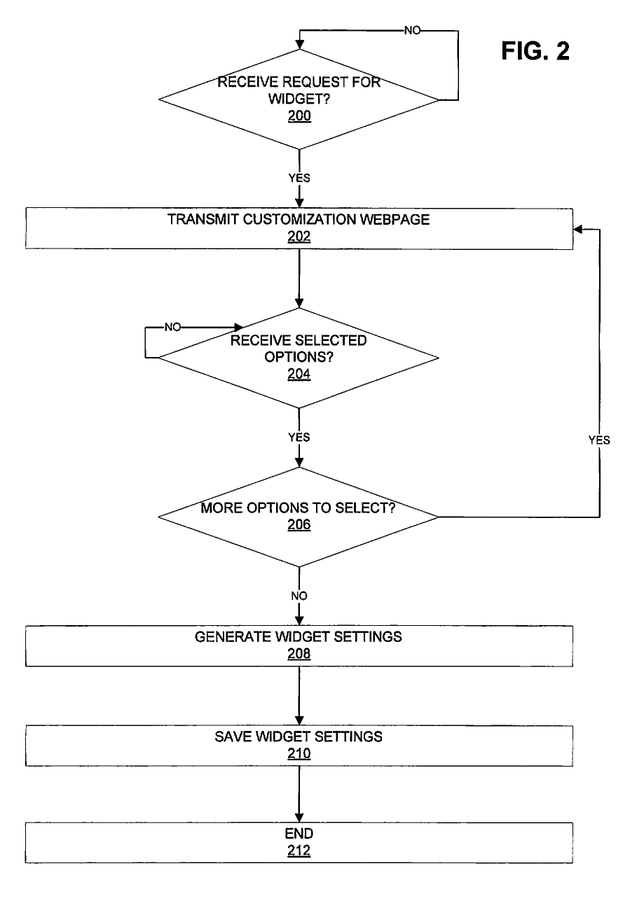

FIG. 2 depicts an example procedure for adding a sales widget to a website. The procedure can execute on a widget server in communication with a web server, as illustrated in FIG. 1, discussed above. In one embodiment, the web server and the widget server may execute on a single system.

In 200, the web server can receive a request to create a sales widget from a website administrator. For example, the website administrator can access the web server from a browser over the Internet or a local network. If a request is received, the server proceeds to 202. If no request is received, the server remains at 200.

In 202, the web server can transmit a customization webpage to the website administrator. The customization webpage includes user-selectable options that will determine widget settings associated with the newly created sales widget. For example, user-selectable options can include a sales widget appearance, a product or service to be sold via the sales widget, a schedule or other system for varying the product or service offered for sale, a fulfillment option (such as utilizing a drop-shipper or an internal sales department), and a price for the product or service.

It will be appreciated that prices for products offered by drop-shippers can be expressed as a markup percentage or a fixed price over the drop-shipper's price. Further, the widget server can take a percentage of sales transactions processed by the sales widget or a fixed amount for each processed sales transaction in exchange for providing the sales widget and widget server to the web server administrator. In one embodiment, a website administrator fulfills all purchase orders and the web server includes a markup percentage over administrator-specified sale prices as a fee.

In 204, the server tests whether the selected options are received. If yes, the server proceeds to 206. If no, the server remains at 204.

In 206, the widget server tests whether more options need to be set by the web server administrator. If yes, an additional customization webpage is transmitted to the web server administrator in 202. Options may be set in a subsequent customization webpage if its possible values are dependent on a previously set option. For example, a video stream associated with a sales widget cannot be selected until the sales widget is configured to synchronize with the video stream, as discussed above.

If no, the server proceeds to 208.

In 208, the widget server then generates relevant widget settings for the user-selected options. The widget settings are stored in a memory accessible to the widget server for later retrieval when the widget is to be executed at a browser.

In another embodiment, the widget server can analyze the website and determine relevant products or services to offer via the sales widget. For example, the widget server can analyze the keyword frequency and other website ranking methods to determine relevancy.

This simplifies the sales widget creation process, as the web server administrator does not need to select products and services for sale from potentially a large list of possible products and services.

In another embodiment, a website server can elect to place a sales widget in exchange for a fee. Entities that wish to extend the reach of their sales efforts can pay the widget server to offer their products and services on such websites. Instead of merely displaying a text advertisement that links to a merchant webpage, the widget offers a product for immediate sale to the visitor of the webpage without requiring the visitor to visit another website.

In 210, the server saves the widget settings to an accessible storage device.

In 212, the server exits the procedure.

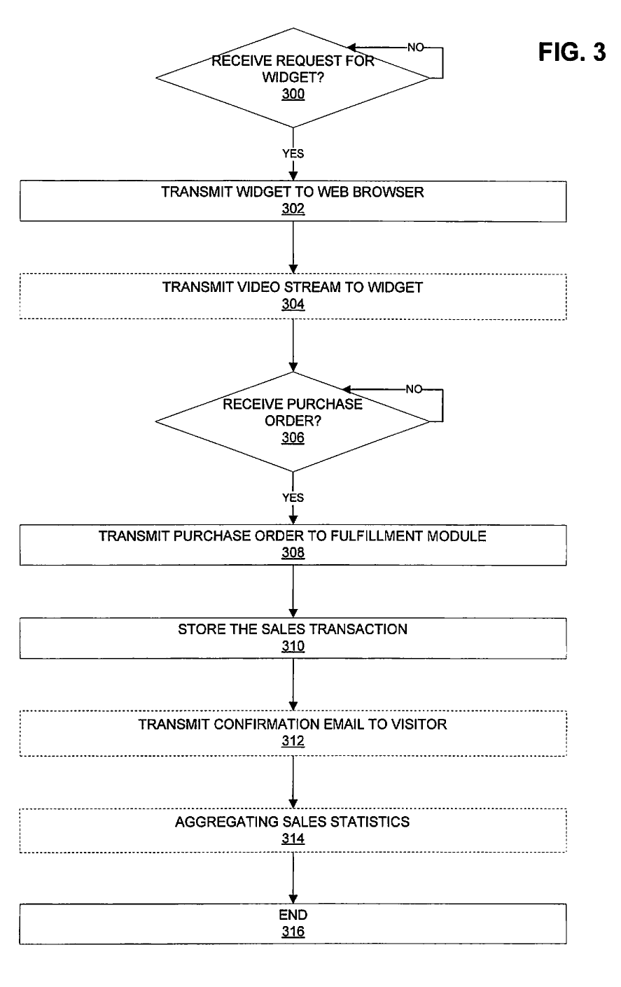

FIG. 3 depicts an example procedure for completing a sales transaction with a sales widget from a website. The procedure can execute on a widget server, as illustrated in FIG. 1, discussed above.

In 300, the widget server tests whether a request for a widget has been received. For example, a URL address pointing to the widget server specifying a widget to be executed can be embedded in a webpage transmitted to a visitor's browser. The browser can transmit a request for the sales widget on parsing the webpage.

If such a request from a browser is received, the widget server proceeds to 302. If no request is received, the widget server remains at 300.

In 302, the widget server retrieves a sales widget from memory and transmits the sales widget to the browser for execution. The sales widget can be transmitted along with widget settings also retrieved from memory.

In 304, an associated video stream or any other content is transmitted to the executing widget or along with the widget. In one embodiment, the widget server checks whether any content is associated with the sales widget and transmits the content immediately after the sales widget. In another embodiment, the widget server waits for the sales widget to begin execution on the browser and transmits a request for the content.

In one embodiment, the video stream is live and can be customized for each visitor and widget. Thus, customer questions or concerns can be addressed in the live video stream.

In 306, the widget server tests whether a purchase order is received from the executing widget. The sales widget is configured to display at least one product or service for sale, and will begin a sales transaction responsive to a visitor, for example, clicking on the widget in the browser. If an order is received, the widget server proceeds to 308. If no order is received, the widget server remains at 306.

In 308, responsive to receiving an indication of a visitor's desire to purchase a product or service, the widget collects and transmits purchase order information, such as the customer's shipping information, a purchase order, and payment information. The widget server verifies the purchase order and processes the payment. If the purchase order is valid, it is transmitted to a fulfillment module for fulfillment. As discussed above, the fulfillment module can be a third-party module, such as a drop-shipper, or an in-house fulfillment module.

In one embodiment, the order collection, verification, and transmission are all executed by the widget. In another embodiment, the process can be divided between the widget and the server.

In 310, the widget server will store the information of the purchase order as a completed sales transaction in an accessible memory.

In 312, the widget server can optionally transmit a confirmation email to the visitor with details of the completed sales transaction, along with any administrative details such as customer service contact information.

In 314, the widget server can optionally aggregate sales statistics responsive to a web server administer request. For example, sales statistics can be collected and displayed by sale date, sales amount, an originating webpage, visitor, or any other criteria. Viewing aggregated sales statistics can allow the web server administrator to optimize product mix, widget placement, product pricing, etc. to maximize revenue or profits.

In addition, the web server administrator can analyze visitor purchasing habits. For example, each visitor may be associated with a visitor identifier on the website, and individual purchases can be associated with visitor identifiers over time. Such purchasing habit information can be useful in targeted marketing, for example, by sending relevant discount codes to selected visitors.

In another embodiment, the visitor can initiate or accept a live text chat with a representative through the widget server. This provides immediate customer service to the visitor.

In 316, the server can exit the procedure.

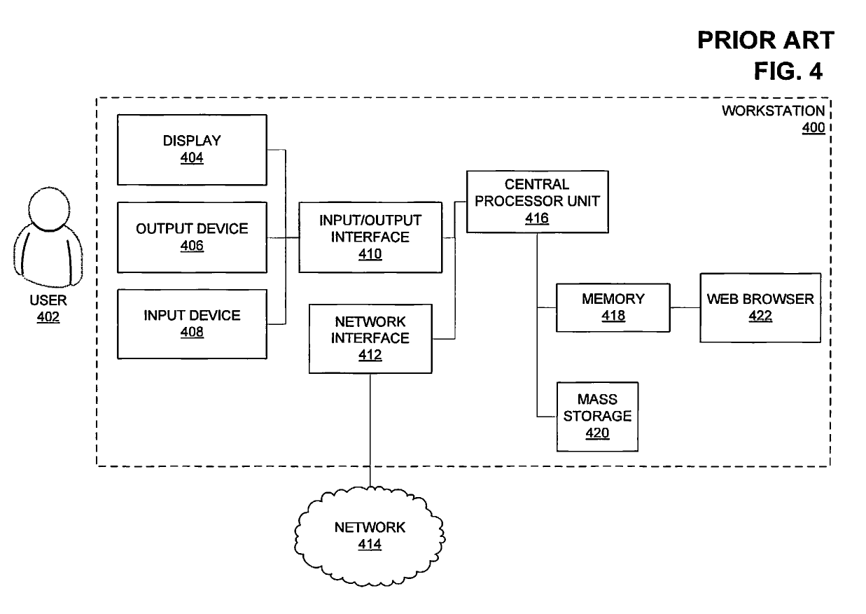

FIG. 4 depicts an example prior art workstation allowing a user to access a website. The workstation 400 can provide a user interface to a user 402. In one example, the workstation 400 can be configured to browse websites over the Internet.

The workstation 400 can be a computing device such as a personal computer, desktop, laptop, a personal digital assistant (PDA) or other computing device. The workstation 400 is accessible to the user 402 and provides a computing platform for various applications.

The workstation 400 can include a display 404. The display 404 can be physical equipment that displays viewable images and text generated by the workstation 400. For example, the display 404 can be a cathode ray tube or a flat panel display such as a TFT LCD. The display 404 includes a display surface, circuitry to generate a picture from electronic signals sent by the workstation 400, and an enclosure or case. The display 404 can interface with an input/output interface 410, which translate data from the workstation 400 to signals for the display 404.

The workstation 400 may include one or more output devices 406. The output device 406 can be hardware used to communicate outputs to the user. For example, the output device 406 can include speakers and printers, in addition to the display 404 discussed above.

The workstation 400 may include one or more input devices 408. The input device 408 can be any computer hardware used to translate inputs received from the user 402 into data usable by the workstation 400. The input device 408 can be keyboards, mouse pointer devices, microphones, scanners, video and digital cameras, etc.

The workstation 400 includes an input/output interface 410. The input/output interface 410 can include logic and physical ports used to connect and control peripheral devices, such as output devices 406 and input devices 408. For example, the input/output interface 410 can allow input device 408 and output device 406 to be connected to the workstation 400.

The workstation 400 includes a network interface 412. The network interface 412 includes logic and physical ports used to connect to one or more networks. For example, the network interface 412 can accept a physical network connection and interface between the network and the workstation by translating communications between the two. Example networks can include Ethernet, the Internet, or other physical network infrastructure. Alternatively, the network interface 412 can be configured to interface with a wireless network. Alternatively, the workstation 400 can include multiple network interfaces for interfacing with multiple networks.

The workstation 400 communicates with a network 414 via the network interface 412. The network 414 can be any network configured to carry digital information. For example, the network 414 can be an Ethernet network, the Internet, a wireless network, a cellular data network, or any Local Area Network or Wide Area Network.

The workstation 400 includes a central processing unit (CPU) 416. The CPU 416 can be an integrated circuit configured for mass-production and suited for a variety of computing applications. The CPU 416 can be installed on a motherboard within the workstation 400 and control other workstation components. The CPU 416 can communicate with the other workstation components via a bus, a physical interchange, or other communication channel.

The workstation 400 includes a memory 418. The memory 418 can include volatile and non-volatile memory accessible to the CPU 416. The memory can be random access and store data required by the CPU 416 to execute installed applications. In an alternative, the CPU 416 can include on-board cache memory for faster performance.

The workstation 400 includes mass storage 420. The mass storage 420 can be non-volatile storage configured to store large amounts of data. The mass storage 420 can be accessible to the CPU 416 via a bus, a physical interchange, or other communication channel. For example, the mass storage 420 can be a hard drive, a RAID array, flash memory, CD-ROMs, DVDs, HD-DVD or Blu-Ray mediums.

The workstation 400 can include a web browser 422. The web browser 422 can be configured to retrieve and display web pages over a network such as the Internet, as discussed above. The web browser 422 can also execute received widgets, as discussed above.

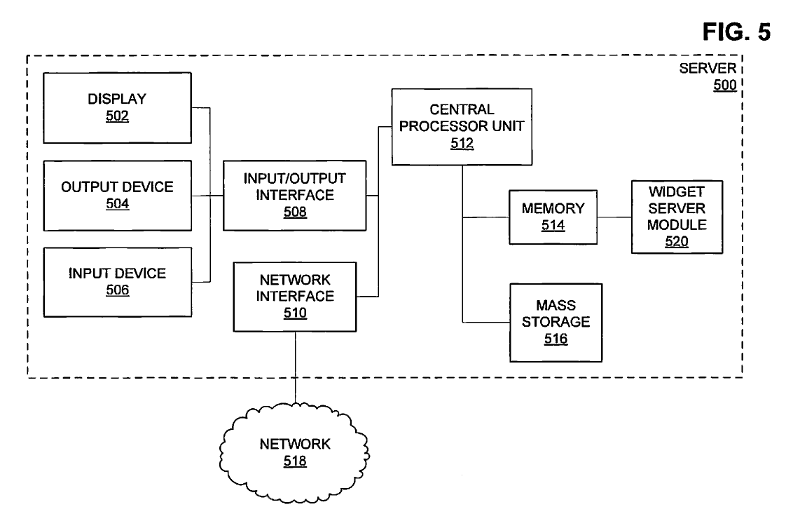

FIG. 5 depicts an example widget server for serving widgets over a network. A widget server 500 is configured to process requests received from a web browser, as discussed above. For example, the server 500 can be configured to communicate with one or more workstations over a plurality of networks.

The server 500 includes a display 502. The display 502 can be equipment that displays viewable images, graphics, and text generated by the server 500 to a user. For example, the display 502 can be a cathode ray tube or a flat panel display such as a TFT LCD. The display 502 includes a display surface, circuitry to generate a viewable picture from electronic signals sent by the server 500, and an enclosure or case. The display 502 can interface with an input/output interface 508, which converts data from a central processor unit 512 to a format compatible with the display 502.

The server 500 includes one or more output devices 504. The output device 504 can be any hardware used to communicate outputs to the user. For example, the output device 504 can be audio speakers and printers or other devices for providing output.

The server 500 includes one or more input devices 506. The input device 506 can be any computer hardware used to receive inputs from the user. The input device 506 can include keyboards, mouse pointer devices, microphones, scanners, video and digital cameras, etc.

The server 500 includes an input/output interface 508. The input/output interface 508 can include logic and physical ports used to connect and control peripheral devices, such as output devices 504 and input devices 506. For example, the input/output interface 508 can allow input and output devices 504 and 506 to communicate with the server 500.

The server 500 includes a network interface 510. The network interface 510 includes logic and physical ports used to connect to one or more networks. For example, the network interface 510 can accept a physical network connection and interface between the network and the workstation by translating communications between the two. Example networks can include Ethernet, or other physical network infrastructure. Alternatively, the network interface 510 can be configured to interface with wireless network. Alternatively, the server 500 can include multiple network interfaces for interfacing with multiple networks.

The server 500 includes a central processing unit (CPU) 512. The CPU 512 can be an integrated circuit configured for mass-production and suited for a variety of computing applications. The CPU 512 can sit on a motherboard within the server 500 and control other workstation components. The CPU 512 can communicate with the other workstation components via a bus, a physical interchange, or other communication channel.

The server 500 includes memory 514. The memory 514 can include volatile and non-volatile memory accessible to the CPU 512. The memory can be random access and provide fast access for graphics-related or other calculations. In one embodiment, the CPU 512 can include on-board cache memory for faster performance.

The server 500 includes mass storage 516. The mass storage 516 can be volatile or non-volatile storage configured to store large amounts of data. The mass storage 516 can be accessible to the CPU 512 via a bus, a physical interchange, or other communication channel. For example, the mass storage 516 can be a hard drive, a RAID array, flash memory, CD-ROMs, DVDs, HD-DVD or Blu-Ray mediums.

The server 500 communicates with a network 518 via the network interface 510. The network 518 can be as discussed. The server 500 can communicate with a mobile device over the cellular network 518.

Alternatively, the network interface 510 can communicate over any network configured to carry digital information. For example, the network interface 510 can communicate over an Ethernet network, the Internet, a wireless network, a cellular data network, or any Local Area Network or Wide Area Network.

The server 500 can execute a widget server module 520 stored in the memory 514. The widget server module 520 can provide widget server functionality, such as receiving widget settings, transmitting widgets to web browsers, and processing purchase orders, as discussed above.

It will be appreciated that the web server can be similar to the widget server 500, except the widget server module 526 is replaced with a conventional web server module.

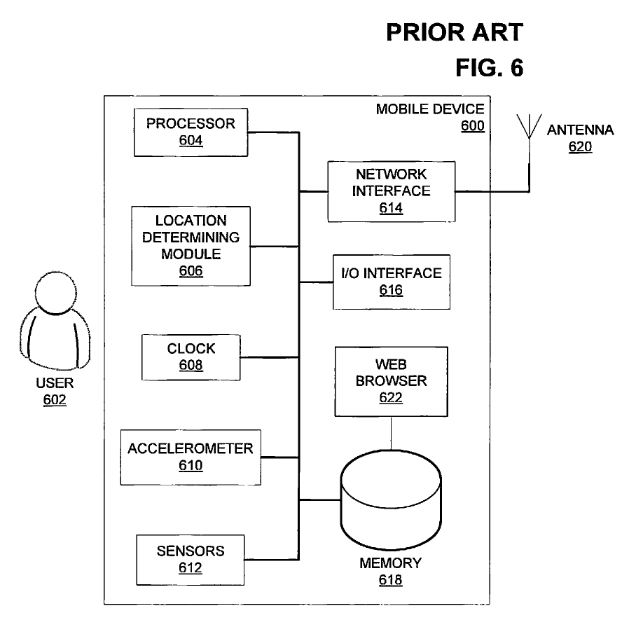

FIG. 6 illustrates an example prior art mobile device allowing a user to access a website. The mobile device 600 can be a cellular phone, a PDA, or a similar wireless portable device used by a user 602. The mobile device 600 is configured to access a prepaid online service or software system, as discussed above.

The mobile device 600 can include a processor 604. The processor 604 can be a general purpose processor configured to execute computer-readable instructions operating the mobile device 600 and associated peripherals. It will be appreciated that any number of processors can be included in the mobile device 600, including specialized processors.

The mobile device 600 can include a location determining module 606. The module 606 can be a GPS receiver module configured to receive GPS signals and calculate a physical location of the mobile device 600 based on the received GPS signals and an internal clock time. The physical location calculation can be optimized by, for example, averaging the GPS signals over time or incorporating a signal from a known nearby location.

Alternatively, the module 606 can calculate a physical location by cellular signal triangulation or via short-range wireless network detection.

The mobile device 600 can include a clock 608. The clock 608 can provide a local time. The clock 608 can also provide an internal time for use with the GPS module. The clock 608 can be periodically updated from a server in communications with the mobile device 600.

The mobile device 600 includes an accelerometer 610. The accelerometer 610 can be configured to detect movement of the mobile device 600 and convert the movement into digital signals transmitted to the processor 604.

The mobile device 600 includes additional sensors 612. Additional sensors can include audio input devices or optical input devices. Audio input devices can include microphones. Optical input devices can include cameras or light sensors. The sensors 612 can be configured to detect appropriate input and convert the input into input signals transmitted to the processor 602.

The mobile device 600 can include a network interface 614. For example, the network interface 614 can communicate with a cellular wireless network, a wired network such as Ethernet, or a short range wireless network such as Bluetooth or Wi-Fi. The mobile device 600 can include multiple network interfaces or a network interface configured to interface with multiple networks. Wireless network interfaces can communicate via an antenna 260.

An Ethernet network allows the mobile device 600 to communicate when plugged in. The mobile device 600 can be assigned an IP address on the wired network. A short-range wireless network can be a Wi-Fi, Wi-Bree or Bluetooth network.

The mobile device 600 can include an input/output interface 616. The interface 616 can receive user inputs from an input device and convert the user inputs into user commands. For example, input devices can include a touch screen display, a keypad, a microphone, an optical device, a pointer device, a scroll wheel, or other input devices.

The interface 616 can also transmit output to an output device in a form accessible to the user 602. For example, output devices can include a touch screen, a display screen, a speaker, an audio-out jack, an electro-mechanical motor for providing tactile output, or other output devices.

The mobile device 600 can include a memory 618. The memory 618 can be read-only or read-write, persistent or volatile storage memory accessible to the processor 604. The memory 618 can store data required by the mobile device 600 for operation and applications for execution.

The mobile device 600 can include an antenna 620. The antenna 620 can be configured to transmit and receive wireless signals from a wireless network.

The mobile device 600 can store a web browser 622. The web browser 622 can be configured to retrieve and display a web page, and execute a widget responsive to user request. The web browser 622 can be similar to the web browser executing on a workstation discussed above.

It will be appreciated that a widget executing on the mobile device 600 can retrieve sensor readings from the location determining module 606, the clock 608, the accelerometer 610, and sensors 612 for transmission to a widget server. Such readings can be utilized by the widget server to select relevant ads to the web browser 622 for display.

As discussed above, one embodiment of the present invention can be a method for completing a web-based sales transaction. The method includes selecting a sales offer, in part, based on a content of a webpage. The method includes, responsive to a request for a widget from a web browser parsing the webpage, transmitting the widget to the web browser for execution and display on the webpage, wherein the widget displays the sales offer. The method includes receiving a purchase order from the widget submitted by a user. The method includes transmitting the purchase order to a fulfillment module for fulfillment. The method includes storing the purchase order and related information as a sales transaction. The fulfillment module can be a third party server. The widget can be associated with a video stream. The method includes transmitting a video stream to the widget for display to the visitor. The purchase order can include multiple products stored in a site shopping cart. The method includes aggregating sales statistics of prior purchase orders received from the widget. The method includes, responsive to an administrator request, displaying the aggregated sales statistics. The method includes, responsive to receiving administrator-selected options, generating widget settings associated with the widget, wherein administrator-selected options include a fulfillment method, selected products to sell via the widget, and prices of the selected products.

Another embodiment of the present invention can be a server for completing a web-based sales transaction. The system includes a memory, the memory configured to store a plurality of sales offers. The system includes a network interface. The system includes a processor. The processor is configured to select a sales offer from the plurality of sales offers, in part, based on a content of a webpage. The processor is configured to, responsive to a request for a widget from a web browser parsing the webpage, transmit the widget to the web browser for execution and display on the webpage, wherein the widget displays the sales offer, wherein the request is received via the network interface. The processor is configured to receive a purchase order from the widget submitted by a user. The processor is configured to transmit the purchase order to a fulfillment module for fulfillment. The processor is configured to store the purchase order and related information as a sales transaction. The fulfillment module can be a third party server. The widget can be associated with a video stream. The processor is configured to transmit a video stream to the widget for display to the visitor. The purchase order can include multiple products stored in a site shopping cart. The processor is configured to aggregate sales statistics of prior purchase orders received from the widget. The processor is configured to, responsive to an administrator request, display the aggregated sales statistics. The processor is configured to, responsive to receiving administrator-selected options, generate widget settings associated with the widget, wherein administrator-selected options include a fulfillment method, selected products to sell via the widget, and prices of the selected products.

Another embodiment of the present invention can be a computer-readable storage medium including instructions for execution on a processor, the instructions adapted to provide a method for completing a web-based sales transaction. The method includes selecting a sales offer, in part, based on a content of a webpage. The method includes, responsive to a request for a widget from a web browser parsing the webpage, transmitting the widget to the web browser for execution and display on the webpage, wherein the widget displays the sales offer. The method includes receiving a purchase order from the widget submitted by a user. The method includes transmitting the purchase order to a fulfillment module for fulfillment. The method includes storing the purchase order and related information as a sales transaction. The fulfillment module can be a third party server. The widget can be associated with a video stream. The method includes transmitting a video stream to the widget for display to the visitor. The purchase order can include multiple products stored in a site shopping cart. The method includes aggregating sales statistics of prior purchase orders received from the widget. The method includes, responsive to an administrator request, displaying the aggregated sales statistics. The method includes, responsive to receiving administrator-selected options, generating widget settings associated with the widget, wherein administrator-selected options include a fulfillment method, selected products to sell via the widget, and prices of the selected products.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for completing a web-based sales transaction, comprising:
selecting a sales offer, in part, based on a content of a webpage;
responsive to a request for a widget from a web browser parsing the webpage, transmitting the widget to the web browser for execution and display on the webpage, wherein the widget displays the sales offer;
receiving a purchase order from the widget submitted by a user;
transmitting the purchase order to a fulfillment module for fulfillment; and
storing the purchase order and related information as a sales transaction.

2. The method of claim 1, wherein the fulfillment module is a third party server.

3. The method of claim 1, wherein the widget is associated with a video stream.

4. The method of claim 3, further comprising:
transmitting a video stream to the widget for display to the visitor.

5. The method of claim 1, wherein the purchase order includes multiple products stored in a site shopping cart.

6. The method of claim 1, further comprising:
aggregating sales statistics of prior purchase orders received from the widget; and
responsive to an administrator request, displaying the aggregated sales statistics.

7. The method of claim 1, further comprising:
responsive to receiving administrator-selected options, generating widget settings associated with the widget, wherein administrator-selected options include a fulfillment method, selected products to sell via the widget, and prices of the selected products.

8. A server for completing a web-based sales transaction, comprising:
a memory, the memory configured to store a plurality of sales offers;
a network interface; and
a processor, the processor configured to
select a sales offer from the plurality of sales offers, in part, based on a content of a webpage,
responsive to a request for a widget from a web browser parsing the webpage, transmit the widget to the web browser for execution and display on the webpage, wherein the widget displays the sales offer, wherein the request is received via the network interface,
receive a purchase order from the widget submitted by a user,
transmit the purchase order to a fulfillment module for fulfillment, and
store the purchase order and related information as a sales transaction.

9. The server of claim 8, wherein the fulfillment module is a third party server.

10. The server of claim 8, wherein the widget is associated with a video stream.

11. The server of claim 10, the processor further configured to transmit a video stream to the widget for display to the visitor.

12. The server of claim 8, wherein the purchase order includes multiple products stored in a site shopping cart.

13. The server of claim 8, the processor further configured to
aggregate sales statistics of prior purchase orders received from the widget, and
responsive to an administrator request, display the aggregated sales statistics.

14. The server of claim 8, the processor further configured to
responsive to receiving administrator-selected options, generate widget settings associated with the widget, wherein administrator-selected options include a fulfillment method, selected products to sell via the widget, and prices of the selected products.

15. A computer-readable storage medium including instructions for execution on a processor, the instructions adapted to provide a method for completing a web-based sales transaction, the method comprising:
selecting a sales offer, in part, based on a content of a webpage;
responsive to a request for a widget from a web browser parsing the webpage, transmitting the widget to the web browser for execution and display on the webpage, wherein the widget displays the sales offer;
receiving a purchase order from the widget submitted by a user;
transmitting the purchase order to a fulfillment module for fulfillment; and
storing the purchase order and related information as a sales transaction.

16. The medium of claim 15, wherein the fulfillment module is a third party server.

17. The medium of claim 15, wherein the widget is associated with a video stream.

18. The medium of claim 17, the method further comprising:
transmitting a video stream to the widget for display to the visitor.

19. The medium of claim 15, wherein the purchase order includes multiple products stored in a site shopping cart.

20. The medium of claim 15, the method further comprising:
aggregating sales statistics of prior purchase orders received from the widget;
responsive to an administrator request, displaying the aggregated sales statistics; and
responsive to receiving administrator-selected options, generating widget settings associated with the widget, wherein administrator-selected options include a fulfillment method, selected products to sell via the widget, and prices of the selected products.
